(19) United States
(12) Patent Application Publication
(10) Pub. No.: US 2003/0044114 A1
(43) Pub. Date: Mar. 6, 2003

(54) Source wavelength shifting apparatus and method for delivery of one or more selected emission wavelengths

(76) Inventor: David G. Pelka, Los Angeles, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 09/948,507

(22) Filed: Sep. 6, 2001

(51) Int. Cl. G02B 6/26

(52) U.S. Cl. 385/31; 385/27; 385/39; 385/123

(57) ABSTRACT

A light delivery apparatus comprises a waveguide, a pump source and a fluorescent emitter. Pump light from the pump source is transmitted through the waveguide to the emitter. The emitter comprises a plurality of quantum dots. The pump light is absorbed by the quantum dots and re-emitted as light with a predetermined wavelength that is longer than the wavelength of the pump light. The predetermined wavelength of the emitted light is selected to match one or more activation wavelength(s) of a photoactivated chemical.

### BACKGROUND OF THE INVENTION

1. Field of the Invention

The present invention relates generally to an apparatus and method for modifying a source (or pump) wavelength such that the shifted wavelength emission corresponds to at least one absorption wavelength for materials such as photodynamic therapy drugs, light curing epoxies or grow lights for algae or the like.

2. Description of the Related Art

Photo-activated compounds have been employed in various medical and other light activated applications. One such application is photodynamic chemotherapy for the treatment of certain types of cancers. A photoreactive drug is introduced into a body and drug molecules remain longer in diseased (e.g., cancerous) tissue than in normal tissue. When the drug is activated with a given wavelength, it becomes toxic to the cancer cells.

Typically, the photoreactive drug is activated by monochromatic laser light. The light is delivered to the diseased tissue area by an optical waveguide, commonly an optical fiber. Since monochromatic laser light has a very narrowband wavelength, the light will only activate a photoreactive drug whose activation wavelength matches that of the laser relatively closely. Very often these photoactive drugs have more than one absorption peak typically separated by many tens of nanometers.

Another lighting system comprises a lamp which emits broadband radiation extending over much of the visible range of wavelengths. This system is advantageous in that multiple drugs with different activation wavelengths can be simultaneously activated. Such systems are commonly used when the diseased tissue is within 3 to 5 millimeters centimeters of the patient's skin, which is the approximate usable penetration depth of visible light.

Accordingly, there is a need for an improved light delivery system that is capable of illuminating tissue more than 3 millimeters below skin level while allowing activation of photoreactive drugs at one or more selected wavelengths.

### SUMMARY OF THE INVENTION

The aforementioned needs are satisfied by a light delivery apparatus having a fluorescent emitter which emits at one or more predetermined wavelengths.

According to one aspect of the invention, the light delivery apparatus comprises an optical waveguide having a proximal end and a distal end. The proximal end is adapted to receive pump light from a pump light source, and the optical waveguide transmits the pump light towards the distal end of the waveguide. The light delivery apparatus further comprises a fluorescent emitter positioned to receive the pump light. The emitter comprises a plurality of quantum dots which emit light of a predetermined wavelength in response to pump light, wherein the predetermined wavelength is longer than the pump wavelength.

In one embodiment of the invention, the emitter is positioned adjacent the distal end of the optical waveguide. The emitter comprises a proximal end portion and a distal end portion. In this embodiment, the quantum dots are distributed at a core of the emitter, between the proximal and distal end portions. Preferably, a wavelength dependent reflector is positioned to allow transmission of the pump light towards the emitter but to reflect the emitted (fluoresced) radiation with the quantum dot cavity.

Another aspect of the invention comprises a method of delivering light within a body of a living being. The method comprises delivering pump light through an optical waveguide to a location within the body. The method further comprises pumping a fluorescent emitter positioned at such location with the pump light. The pumping comprises illuminating a plurality of quantum dots with the pump light to cause the quantum dots to emit light of predetermined wavelength(s). The method further comprises illuminating the location within the body with the emitted light.

In one method, the emitter is located adjacent a tumor within the body, and the emitted light is selected to activate at least one photoreactive drug present in the tumor.

### BRIEF DESCRIPTION OF THE DRAWINGS

FIG. 1 is a drawing illustrating a light delivery apparatus in one embodiment of the invention;

FIG. 2 is a drawing illustrating the fluorescent emitter structure of the light delivery apparatus depicted in FIG. 1;

FIG. 3 is a drawing schematically illustrating a single quantum dot that is contained in the fluorescent emitter structure of FIGS. 1 and 2; and

FIG. 4 is a schematic diagram showing characteristics of a Bragg reflector.

### DETAILED DESCRIPTION OF THE PREFERRED EMBODIMENT

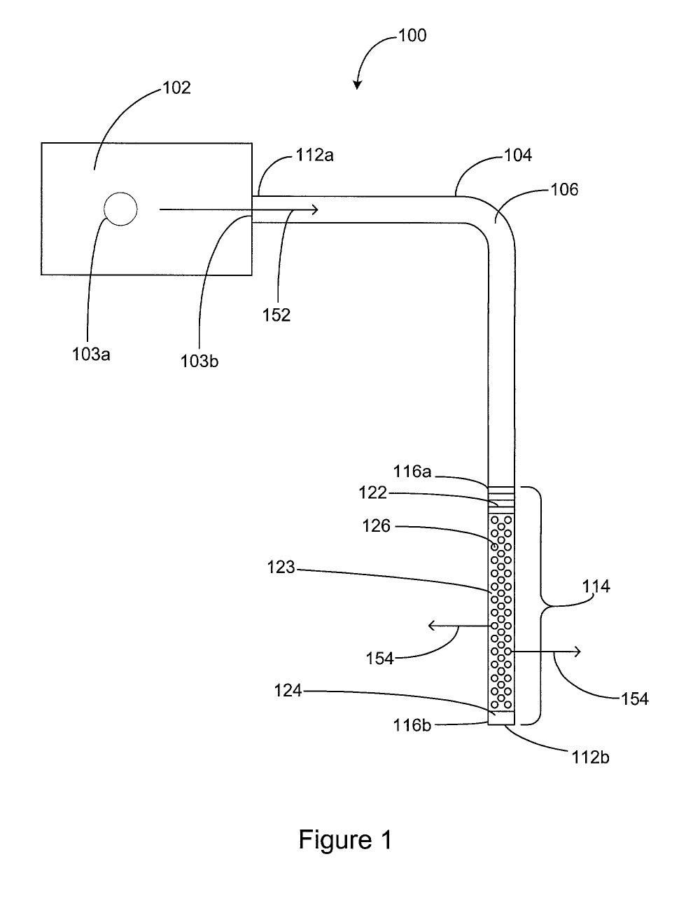

Reference will now be made to the drawings wherein like numerals refer to like parts throughout. FIG. 1 depicts a light delivery apparatus 100 that comprises a pump source 102 and a waveguide catheter 104. The catheter 104 has a proximal end portion 112a and a distal end portion 112b, and comprises an optical waveguide 106, such as an optical fiber having a core and a cladding.

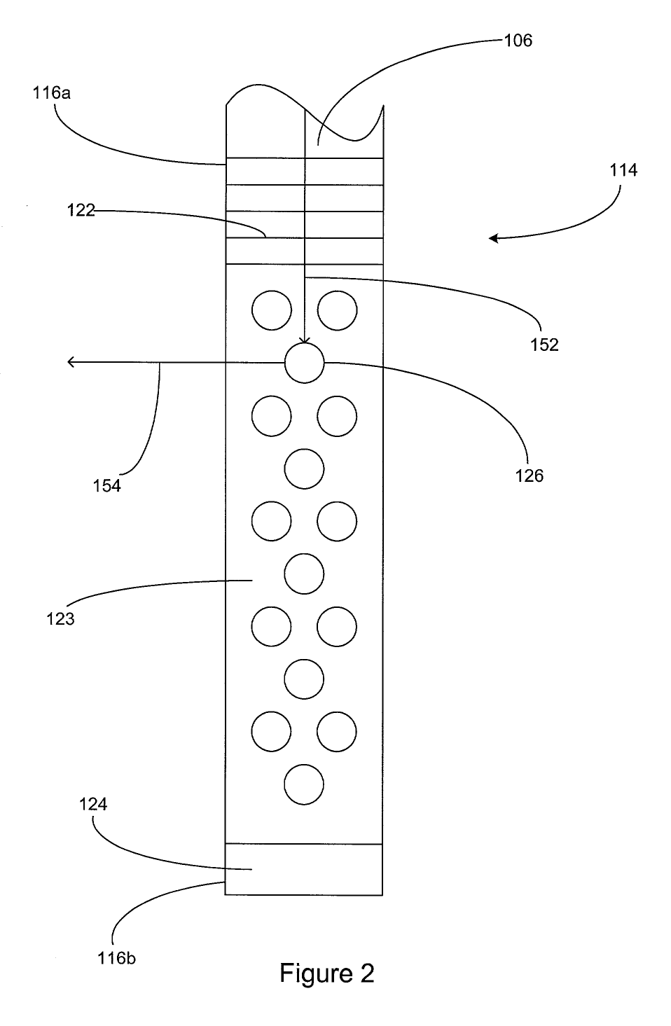

The distal end 112b of the catheter 104 includes an emitter 114 formed by a fluorescent light emitting structure. An enlarged view of the emitter 114 is illustrated in FIG. 2. The emitter 114 has a proximal end portion 116a and a distal end portion 116b such that the proximal end 116a is adjacent to the waveguide 106. A Bragg reflector assembly 122 is disposed at the proximal end 116a, and a broadband specular reflector 124 at the distal end 116b. A volume of quantum dots 123 is disposed between the Bragg reflector assembly 122 and the broadband reflector 124. In one embodiment, the emitter comprises an optical fiber segment with the volume of quantum dots distributed through the core of such segment.

The Bragg reflector 122 comprises transparent material having refractive index variations which cooperate to reflect light of a selected wavelength(s). The Bragg reflector 122 selectively reflects light of specific wavelength(s). It will be understood that the term wavelength refers to a narrowband of electromagnetic radiation.

The broadband reflector 124 specularly reflects light from the volume of quantum dots 123 so as to re-direct the light back to the volume of quantum dots 123, for a purpose that is described below.

The volume of quantum dots 123 comprises a plurality of quantum dots 126 distributed throughout the region between the reflectors 122, 124, preferably in closely spaced relationship. Quantum dots are well known in the art, and are available from numerous sources. One example of quantum dots is sold under the trade name Qdot® and is manufactured and distributed by Quantum Dot Corp. of Palo Alto, Calif.

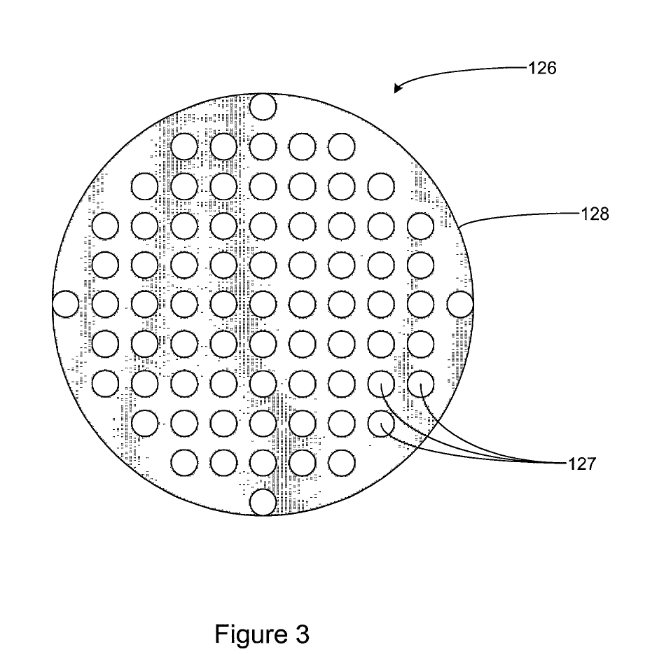

As illustrated in FIG. 3, a single quantum dot 126 comprises a small group of atoms 127 that form an individual particle 128. These quantum dots 126 may comprise various materials including semiconductors such as zinc selenide (ZnSe), cadmium selenide (CdSe), cadmium sulfide (CdS), indium arsenide (InAs), and indium phosphide (InP). Another material that may suitably be employed is titanium dioxide (TiO₂). The size of the particle 128, i.e., the quantum dot 126, may range from about 2 to 10 nm. The size of these particles 128 is so small that quantum physics governs many of its electrical and optical properties. One such result of the application of quantum mechanics to the quantum dot 126 is that quantum dots absorb a broad spectrum of optical wavelengths and re-emit radiation having a wavelength that is longer than the wavelength of the absorbed light. The wavelength of the emitted light is governed by the size of the quantum dot 126. For example, CdSe quantum dots having a 5.0 nm diameter emit radiation having a narrow spectral distribution centered about 625 nm while CdSe quantum dots 126 having a diameter of 2.2 nm emit light having a center wavelength of about 500 nm. Semiconductor quantum dots comprising CdSe, InP, and InAs, can emit radiation having center wavelengths in the range between 400 nm to about 1.5 μm. Titanium dioxide TiO₂ also emits in this range. The linewidth of the emission, i.e., full-width half-maximum (FWHM), for these semiconductor materials may range from about 20 to 30 nm. The quantum dots 126 produce this narrowband emission in response to absording light having one or more wavelengths shorter than the wavelength of the light emitted by the dots. For example, for 5.0 nm diameter CdSe quantum dots, wavelengths shorter than about 625 nm are absorbed to produce emission at about 625 nm, while for 2.2 nm quantum dots of CdSe, wavelengths less than about 500 nm are absorbed and re-emitted at about 500 nm. In practice, however, the excitation or pump radiation is preferably at least about 50 nanometers shorter than the emitted radiation. These and other properties of quantum dots are described in by David Rotman in “Quantum Dot Com,” Technology Review, January/February 2000, pp. 50-57.

The pump source 102 of the light delivery apparatus 100 comprises a light source 103a optically coupled to the proximal end portion 112a of the catheter so as to transmit pump light 152 from the pump source 102 to the waveguide 106. The wavelength(s) of the pump light 152 are shorter than that of emitted light 154 as described above. In one embodiment, the light source 103a is an ultraviolet (UV) lamp.

In operation, the pump source 102 produces pump light 152 with wavelength λₚᵤₘₚ. It will be understood that the wavelength λₚᵤₘₚ may comprise only a single wavelength or may comprise a composite of many wavelengths in discrete or continuous distribution. The pump light 152 enters the proximal end portion 112a of the catheter 104 and is guided through the waveguide 106. Upon reaching the emitter 114, at least a portion of the pump light 152 is absorbed by the quantum dots 126. The quantum dots 126 re-emit the absorbed energy as emitted light 154 with wavelength λ_{emitted} in an isotropic manner, i.e. in all directions. The wavelength λ_{emitted} is determined by the composition of the quantum dots 126, as described above. It will be appreciated that in one embodiment, the emitter 114 contains a mixture of quantum dots 126 tailored to deliver emitted light 154 with a multiplicity of specific wavelengths λ_{emitted}.

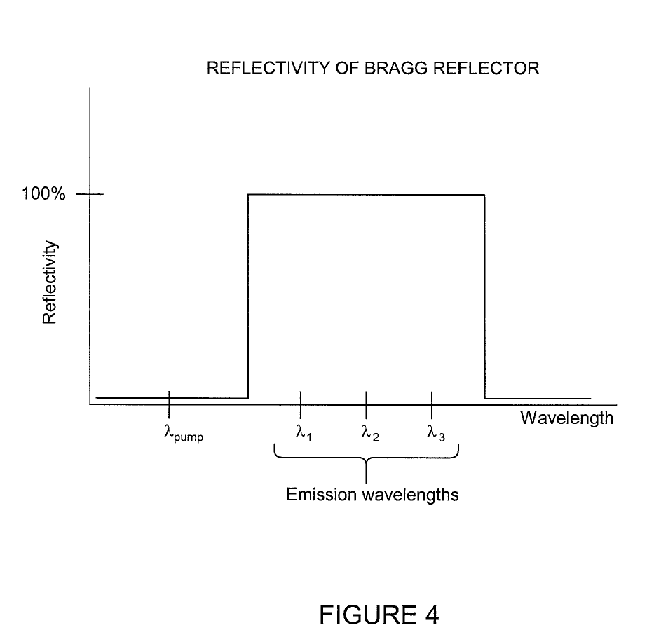

The isotropic emission of the light 154 emitted from the quantum dots 126 means that a portion of the emitted light 154 will propagate from the volume of quantum dots 123 towards the intended target. Some of the emitted light 154 may propagate to either the Bragg reflector 122 or the broadband reflector 124, where it is reflected. For example, as illustrated in FIG. 4, a mixture of three types of quantum dots may be utilized to provide emission at three wavelengths, λ₁, λ₂ and λ₃. The Bragg reflector preferably reflects all of the emission wavelengths while passing the pump wavelength.

The broadband reflector 124 also reflects unabsorbed pump light 152 that is incident thereon. Thus, reflected light further pumps the quantum dots 126, thus permitting the quantum dots 126 to absorb more of the pump light 152.

The combination of the broadband reflector 123 and the Bragg reflector assembly 122 result in increasing the net amount of desired emitted light 154 of wavelength λ_{emitted} being delivered to the target area. In one embodiment of the invention, photoreactive drug(s) are administered to the patient for selective absorption by diseased (e.g., cancerous) tissue. The catheter 104 (FIG. 1) is then surgically inserted into a body tissue 162 through the skin 164 so as to place the emitter 114 in appropriate proximity to such diseased tissue. The photoreactive drug(s) present in the diseased tissue is irradiated by the emitted light 154 so as to activate the drug(s) for therapy.

In another embodiment of the invention, the catheter 104 may be used in a dental environment to cure composite material used to fill cavities. For example, the emitter 114 may be tuned so as to make the emitted light 154 match the curing wavelength of the composite material.

Those skilled in the art will appreciate that the light delivery system 100 has additional applications, such as light curing epoxies, (dental, industrial, etc). Other applications include grow lights for plants, algae, etc., as well as illuminating bacteria and activating light activated DNA fluorescence markers. It will be understood that the relevant applications are not limited to those specifically recited above. Also, the present invention may be embodied in other specific forms without departing from the essential characteristics as described herein. The embodiments described above are to be considered in all respects as illustrative only and not restrictive in any manner.

What is claimed is:

1. An apparatus comprising:
an optical waveguide having a proximal end portion for receiving light having a pump wavelength from a pump light source, said optical waveguide transmitting the pump light from the pump light source towards a distal end portion of the waveguide;
a fluorescent emitter positioned to receive the pump light transmitted by the optical waveguide, said emitter comprised of a plurality of quantum dots which emit light of a predetermined wavelength in response to pumping, said predetermined wavelength longer than the pump wavelength.

2. The apparatus of claim 1, wherein the emitter is positioned at the distal end portion of the optical waveguide, said emitter comprising a proximal end portion and a distal portion, said apparatus additionally comprising a wavelength dependent reflector at the proximal end portion of the emitter, and a broadband reflector at the distal portion of the emitter.

3. The apparatus of claim 1, wherein the emitter comprises an optical fiber segment, and the quantum dots are distributed in the core of the fiber.

4. The apparatus of claim 1, wherein a first portion of the plurality of quantum dots emits radiation at a wavelength different than that of a second portion of the quantum dots.

5. A method of delivering light within a body of a living being, comprising:
delivering pump light through an optical waveguide to a location within the body;
pumping a fluorescent emitter positioned at said location with said pump light, said pumping comprising illuminating a plurality of quantum dots with said pump light to cause the quantum dots to emit light of at least one predetermined wavelength;
illuminating said location with emitted light.

6. The method of claim 5, wherein the emitter location is adjacent to a tumor.

7. The method of claim 5, comprising using the emitted light to activate a photodynamic drug.

8. The method of claim 5, wherein said illuminating comprises curing a material.

9. The method of claim 8, wherein the material comprises an epoxy.

10. The method of claim 5, wherein said illuminating comprises illuminating plant life.

11. The method of claim 10, wherein the plant life comprises algae.

12. The method of claim 5, wherein the illuminating comprises illuminating bacteria.

13. The method of claim 5, wherein the illuminating comprises illuminating a DNA fluorescence marker.

14. The method of claim 5, comprising using a mixture of said quantum dots to provide plural emission wavelengths.

15. The method of claim 14, wherein the plural emission wavelengths substantially match respective absorption peaks of material to be illuminated.
